(19) United States
(12) Patent Application Publication
(10) Pub. No.: US 2020/0175428 A1
(43) Pub. Date: Jun. 4, 2020

(54) Fleet Management System for Autonomous Vehicles with Customer Service Integration

(71) Applicant: Waymo LLC, Mountain View, CA (US)

(72) Inventors: Julien Mercay, Redwood City, CA (US); Laurens Andreas Feenstra, San Francisco, CA (US); Shir Yehoshua, San Francisco, CA (US); Kyle Bechtel, San Francisco, CA (US); Peter Colijn, San Francisco, CA (US); Angela Wise, San Francisco, CA (US)

(21) Appl. No.: 16/204,198

(22) Filed: Nov. 29, 2018

(51) Int. Cl. G06Q 10/02; G06Q 50/30; G06Q 30/00; G08G 1/00; G05D 1/02; G05D 1/00

(52) U.S. Cl. CPC G06Q 10/02; G06Q 50/30; G06Q 30/016; G05D 2201/0213; G05D 1/0291; G05D 1/0088; G08G 1/202

(57) ABSTRACT

The technology relates to assigning customer service requests for a fleet of autonomous vehicles providing trip services. For instance, a message having contents including information about a trip the vehicle is currently servicing may be received from a computing device of an autonomous vehicle of the fleet of vehicles. A request for customer service for the vehicle may be generated based on the contents of the message. A priority of the request may be determined based on the contents of the message. The request may be inserted into a queue based on the priority. The request may be assigned to a customer service representative based on a place of the request in the queue.

### BACKGROUND

Autonomous vehicles, such as vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. However, in situations in which a passenger has a problem, is concerned or otherwise uncomfortable, there may be human driver in the vehicle communicate with the passenger and reassure him or her that the vehicle is functioning normally, check on the passenger during a ride, and/or provide instructions to the passenger in the event of a problem with the vehicle or other an emergency.

### BRIEF SUMMARY

One aspect of the disclosure provides a method of assigning customer service requests for a fleet of autonomous vehicles providing trip services. The method includes receiving, by one or more server computing devices, from a computing device of an autonomous vehicle of the fleet of vehicles, a message having contents including information about a trip the vehicle is servicing; generating, by the one or more server computing devices, a request for customer service for the vehicle based on the contents of the message; determining, by the one or more server computing devices, a priority level of the request based on the contents of the message; inserting, by the one or more server computing devices, the request into a queue based on the priority level; and assigning, by the one or more server computing devices, the request to a customer service representative based on a place of the request in the queue.

In one example, generating the request is further based on a set of heuristics including whether a trip has been completed. In another example, generating the request is further based on a set of heuristics including whether a trip has ended. In another example, generating the request is further based on a set of heuristics including whether the vehicle appears to be stuck. In another example, generating the request is further based on a lack of messages from the vehicle for a predetermined period of time after the messages is received. In another example, determining the priority level is further based on past history of a passenger of the vehicle. In another example, the message includes an indication that a passenger of the vehicle is requesting customer service, and wherein determining the priority level is further based on the indication. In this example, determining the priority level is further based on a pre-determined level of service for the passenger. In another example, the message is a status message identifying a current status of the vehicle, and wherein determining the priority level is further based on the current status of the vehicle. In another example, determining the priority level is further based on a set of heuristics including whether the vehicle is occupied. In another example, determining the priority level is further based on a set of heuristics including whether the request is related to safety of a passenger. In another example, determining the priority level is further based on a set of heuristics including whether the request is related to safety of the vehicle. In another example, inserting the request into the queue includes selecting the queue from a plurality of queues each having a different associated priority level. In this example, selecting the queue includes identifying one of the plurality of queues having a determined priority level corresponding to the priority level. In addition, assigning the request is based on whether any other queues having a higher priority level than the priority level are empty. In another example, inserting the request includes inserting the request in the queue at a place that is no higher than any other request in the queue with a same priority level as the priority level. In another example, assigning the request is further based on a characteristic of the customer service representative and a type of the request. In another example, the method also includes tracking a status of the customer service representative and updating the status once the request is assigned to the customer service representative. In another example, the method also includes receiving an indication that the customer service representative has closed the request and removing the request form the queue based on the indication. In addition, the indication further indicates that the customer service representative has closed a second request for customer service for the vehicle, wherein the second request was not assigned to the customer service representative, and the method further comprises removing the second request form the queue based on the indication.

### BRIEF DESCRIPTION OF THE DRAWINGS

FIG. 1 is a functional diagram of an example vehicle in accordance with aspects of the disclosure.

FIG. 2 is an example external view of a vehicle in accordance with aspects of the disclosure.

FIG. 3 is an example pictorial diagram of a system in accordance with aspects of the disclosure.

FIG. 4 is an example functional diagram of a system in accordance with aspects of the disclosure.

FIG. 5 is an example of queues and entering a request into a queue in accordance with aspects of the disclosure.

FIG. 6 is an example of a queue and entering a request into the queue in accordance with aspects of the disclosure.

FIG. 7 is an example flow diagram in accordance with aspects of the disclosure.

### DETAILED DESCRIPTION

### Overview

The technology relates to a fleet management system which can connect a vehicle with a customer service representative when needed. For instance, certain circumstances may cause the fleet management system to generate a request for customer service for a given vehicle. These may be prioritized based on the circumstances for the request and entered into one or more queues depending on the priority. The queues may then be assigned to customer representatives in priority order. Because the requests are generated by the fleet management system and not necessarily the vehicles themselves, this may prevent vehicles from calling customer service too often and for unnecessary reasons. The fleet management system can thereby reduce, or otherwise manage, the load on the customer service representatives. In addition, by using priority, the fleet management system is able to prioritize the most important (i.e. highest priority) requests.

The fleet management system may automatically generate requests for customer service based on various input. In some instances, these requests may be based on a current or last reported state of the vehicle. Each vehicle may periodically generate and broadcast a state message to the fleet management fleet management system. The fleet management system may then receive these state messages and determine whether a request for customer service should be generated. This may be done, for instance, based on a set of heuristics.

As another instance, a fleet management system may automatically generate a request based on a lack of status message from a vehicle. For example, if a vehicle goes too long without reporting its status, this may be an indication of a problem at the vehicle. As such, the fleet management system may automatically generate a request. Requests may also be generated based on specific requests made by a passenger or another type of non-customer service representative. As another instance, a request may also be made if the fleet management system detects unexpected input while no passenger is expected in the vehicle. As a further example, a dispatcher or other human agent who notices an issues with a vehicle may send information identifying the problem to the fleet management system.

Once the information is received, the fleet management system may automatically generate a request. A priority level may be determined for each request based on the reason or context for the request being generated. These priority level determination may also be made based on heuristics. Each request may then be assigned to queue based on its determined priority level. In one instance, there may be a plurality of different queues, each with a different priority level associated with it. Here, a request may be inserted to the end of a queue associated with the same priority level as determined for the request. As another instance, there may be a single queue. Rather than inserting the request at the end of the queue, the request may be inserted in the queue at a location that is no higher than any other request with the same determined priority level.

The requests may then be assigned to customer service representatives based on availability and the one or more queues. For instance, wherein there are multiple queues, the oldest or earliest in time request to be inserted into the highest priority level queue may be the next assigned request. In some instance, the assignments may be based on whether a customer service representative meets any requirements of the request. Accordingly, the fleet management system may track the availability of each customer service representative as well as his or her characteristics. In this regard, requests are only assigned to customer service representatives equipped to handle those requests.

The fleet management system may also facilitate a connection between the assigned customer service representative and the vehicle and/or a client computing device of the passenger. The customer service representative may access information about the vehicle, for instance tracked by the fleet management system computing devices, which may include any outstanding requests for that vehicle. The customer service representative may respond to a request, for instance, by communicating with any passengers in the vehicle. Once a customer service representative has addressed the reason for the request and/or communicated with any passengers of the vehicle, the customer service representative may designate the request as completed, closed, etc. In response, the fleet management system may remove the request from its queue.

As noted above, because the requests are generated by the fleet management system and not necessarily the vehicles themselves, this may prevent vehicles from calling customer service too often and for unnecessary reasons thereby dynamically managing (e.g., reducing, limiting, reassigning) the load on the customer service representatives. In addition, by using priority levels, the fleet management system is able to prioritize the most important (i.e. highest priority level) requests and also to moderate the load on any given customer service representative.

### Example Systems

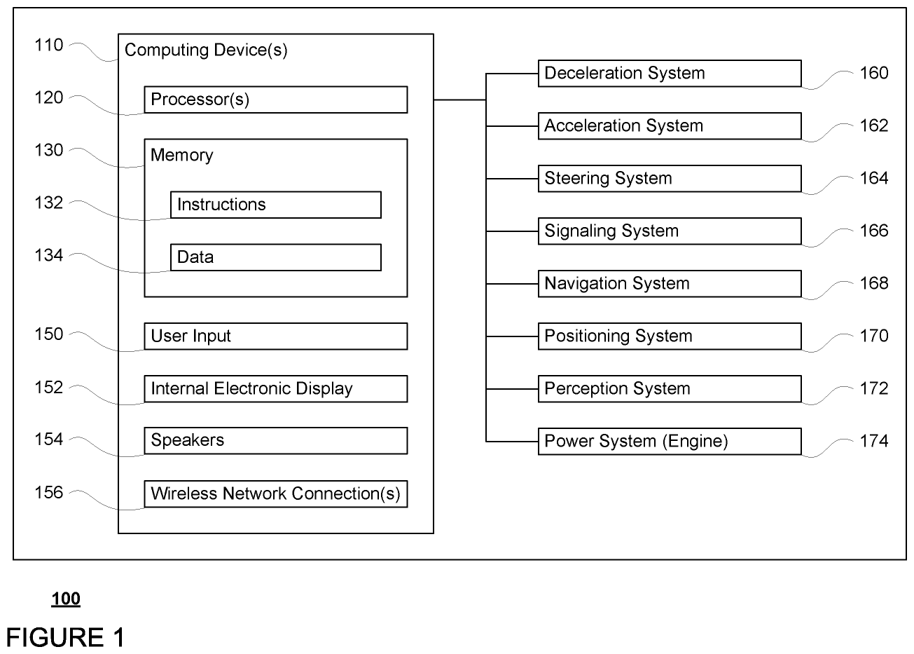

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. As an example, data 134 of memory 130 may store predefined scenarios. A given scenario may identify a set of scenario requirements including a type of object, a range of locations of the object relative to the vehicle, as well as other factors such as whether the autonomous vehicle is able to maneuver around the object, whether the object is using a turn signal, the condition of a traffic light relevant to the current location of the object, whether the object is approaching a stop sign, etc. The requirements may include discrete values, such as “right turn signal is on” or “in a right turn only lane”, or ranges of values such as “having an heading that is oriented at an angle that is 20 to 60 degrees offset from a current path of vehicle 100.” In some examples, the predetermined scenarios may include similar information for multiple objects.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. As an example, internal electronic display 152 may be controlled by a dedicated computing device having its own processor or central processing unit (CPU), memory, etc. which may interface with the computing device 110 via a high-bandwidth or other network connection. In some examples, this computing device may be a user interface computing device which can communicate with a user's client device. Similarly, the memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100. The vehicle may also include one or more wireless network connections 156 to facilitate communicates with devices remote from the vehicle and/or between various systems of the vehicle.

In one example, computing device 110 may be an autonomous driving computing system incorporated into vehicle 100. The autonomous driving computing system may capable of communicating with various components and systems of the vehicle, for instance, wirelessly (via wireless network connections 156) and/or a wired connection (such as a controller area network bus or other communication bus). For example, returning to FIG. 1, computing device 110 may be in communication with various systems of vehicle 100, such as deceleration system 160 (for controlling braking of the vehicle), acceleration system 162 (for controlling acceleration of the vehicle), steering system 164 (for controlling the orientation of the wheels and direction of the vehicle), signaling system 166 (for controlling turn signals), navigation system 168 (for navigating the vehicle to a location or around objects), positioning system 170 (for determining the position of the vehicle), perception system 172 (for detecting objects in the vehicle's environment), and power system 174 (for example, a battery and/or gas or diesel powered engine) in order to control the movement, speed, etc. of vehicle 100 in accordance with the instructions 132 of memory 130 in an autonomous driving mode which does not require or need continuous or periodic input from a passenger of the vehicle. Again, although these systems are shown as external to computing device 110, in actuality, these systems may also be incorporated into computing device 110, again as an autonomous driving computing system for controlling vehicle 100. In addition or alternatively, each of these system may include one or more computing devices having processors and memory, configured the same as or similarly to processors 120 and memory 130 of computing devices 110 in order to enable the functionalities of these systems as described here.

The computing device 110 may control the direction and speed of the vehicle by controlling various components. By way of example, computing device 110 may navigate the vehicle to a destination location completely autonomously using data from the map information and navigation system 168. Computing devices 110 may use the positioning system 170 to determine the vehicle's location and perception system 172 to detect and respond to objects when needed to reach the location safely. In order to do so, computing devices 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

As an example, computing device 110 may interact with deceleration system 160 and acceleration system 162 in order to control the speed of the vehicle. Similarly, steering system 164 may be used by computing device 110 in order to control the direction of vehicle 100. For example, if vehicle 100 configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 134 may store map information, e.g., highly detailed maps that computing devices 110 can use to navigate or control the vehicle. As an example, these maps may identify the shape and elevation of roadways, lane markers, intersections, crosswalks, speed limits, traffic signal lights, buildings, signs, real time or historical traffic information, vegetation, or other such objects and information. The lane markers may include features such as solid or broken double or single lane lines, solid or broken lane lines, reflectors, etc. A given lane may be associated with left and right lane lines or other lane markers that define the boundary of the lane. Thus, most lanes may be bounded by a left edge of one lane line and a right edge of another lane line. As noted above, the map information may store known traffic or congestion information and/or and transit schedules (train, bus, etc.) from a particular pickup location at similar times in the past. This information may even be updated in real time by information received by the computing devices 110.

As an example, the detailed map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

The perception system 172 also includes one or more components for detecting objects external to the vehicle such as other vehicles, obstacles in the roadway, traffic signals, signs, trees, etc. For example, the perception system 172 may include one or more LIDAR sensors, sonar devices, radar units, cameras and/or any other detection devices that record data which may be processed by computing devices 110. The sensors of the perception system may detect objects and their characteristics such as location, orientation, size, shape, type (for instance, vehicle, pedestrian, bicyclist, etc.), heading, speed, acceleration, rate of change of acceleration, deceleration, rate of change of deceleration, etc. The raw data from the sensors and/or the aforementioned characteristics can be quantified or arranged into a descriptive function, vector, and or bounding box and sent for further processing to the computing devices 110 periodically and continuously as it is generated by the perception system 172.

As discussed in further detail below, computing devices 110 may use the positioning system 170 to determine the vehicle's location and perception system 172 to detect and respond to objects when needed to reach the location safely.

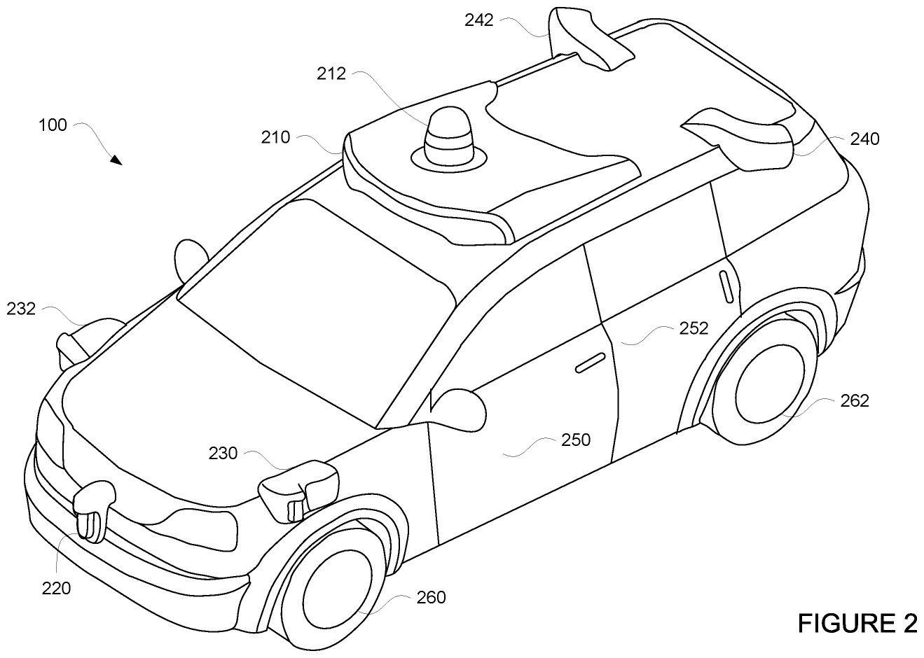

For instance, FIG. 2 is an example external view of vehicle 100. In this example, roof-top housing 210 and dome housing 212 may include a LIDAR sensor as well as various cameras and radar units. In addition, housing 220 located at the front end of vehicle 100 and housings 230, 232 on the driver's and passenger's sides of the vehicle may each store a LIDAR sensor. For example, housing 230 is located in front of driver door 250. Vehicle 100 also includes housings 240, 242 for radar units and/or cameras also located on the roof of vehicle 100. Additional radar units and cameras (not shown) may be located at the front and rear ends of vehicle 100 and/or on other positions along the roof or roof-top housing 210. Vehicle 100 also includes many features of a typical passenger vehicle such as doors 250, 252, wheels 260, 262, etc.

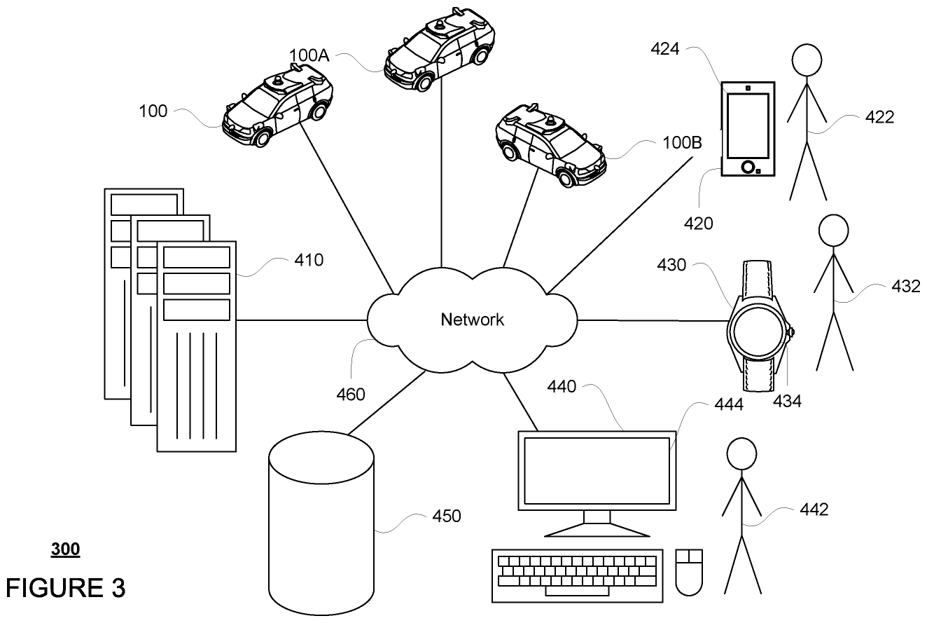

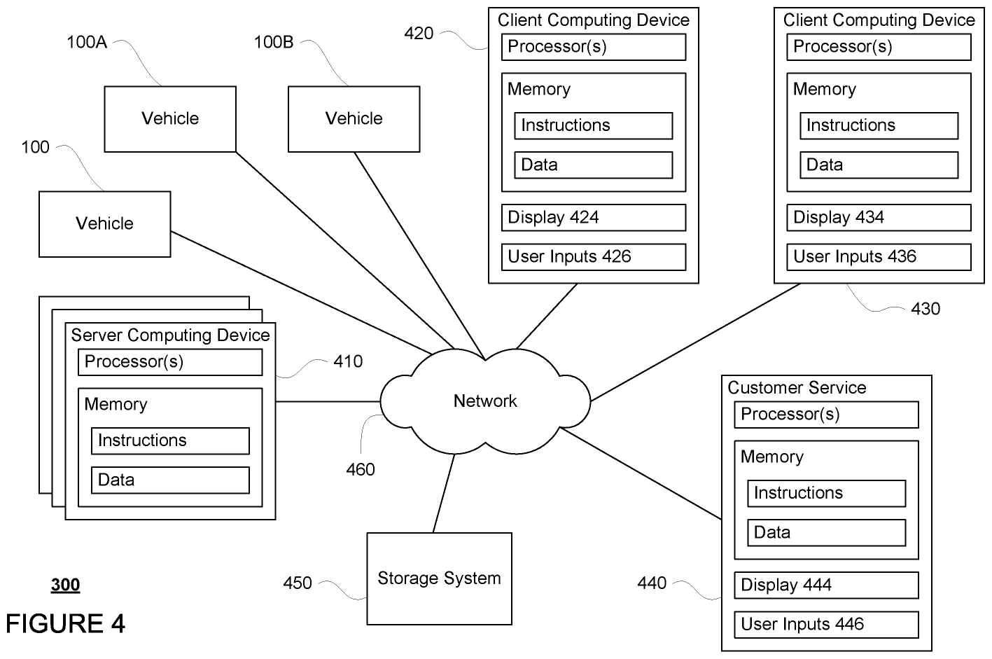

Computing device 110 of vehicle 100 may also receive or transfer information to and from other computing devices, such as those computing devices that are a part of the transportation service as well as other computing devices. FIGS. 3 and 4 are pictorial and functional diagrams, respectively, of an example system 300 that includes a plurality of computing devices 410, 420, 430, 440 and a storage system 450 connected via a network 460. System 300 also includes vehicle 100, and vehicles 100A, 100B which may be configured the same as or similarly to vehicle 100. Although only a few vehicles and computing devices are depicted for simplicity, a typical system may include significantly more.

As shown in FIG. 4, each of computing devices 410, 420, 430, 440 may include one or more processors, memory, data and instructions. Such processors, memories, data and instructions may be configured similarly to one or more processors 120, memory 130, data 134, and instructions 132 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 110 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A, 100B as well as computing devices 420, 430, 440 via the network 460. For example, vehicles 100, 100A, 100B may be a part of a fleet of vehicles that can send and receive information from the server computing devices 410. In this regard, the server computing devices 410 together may function as a fleet management system, each of the server computing devices functioning to perform one or more roles of the fleet management system. In addition, the server computing devices of the fleet management system may use network 460 to transmit and present information to a user, such as user 422, 432, 442 on a display, such as displays 424, 434, 444 of computing devices 420, 430, 440. In this regard, computing devices 420, 430, 440 may be considered client computing devices.

Returning to FIG. 3, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), speakers, and user input devices 426, 436, 446 (e.g., a mouse, keyboard, touchscreen or microphone). The client computing devices may also include a camera for recording video streams, speakers, a network interface device, and all of the components used for connecting these elements to one another.

Client computing device 440 may also be a work station for a customer service representative. In this regard, user 422 may be a customer service representative who can communicate with passengers of the vehicles 100, 100A, and 100B when connected by a server computing device as discussed further below. In addition, the client computing device 440 may enable the user 422 to access information about the vehicles of the fleet stored in the storage system 450, for instance, by communicating with the server computing devices 410 of fleet management system over network 460. Again, although only a single customer service work station is depicted in FIGS. 3 and 4, the system may actually include tens or hundreds of such work stations and customer service representative.

Although the client computing devices 420, 430, and 440 may each comprise a full-sized personal computing device, they may alternatively comprise mobile computing devices capable of wirelessly exchanging data with a server computing device (such as the server computing devices 410) over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 4. As an example the user may input information using a small keyboard, a keypad, microphone, using visual signals with a camera, or a touch screen.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of the computing devices 110, 410, 420, 430, 440, etc.

Storage system 450 may store various types of information as described in more detail below. This information may be retrieved or otherwise accessed by one or more server computing devices, such as those of the fleet management system, and/or one or more client computing device, such as the client computing device 440, in order to perform some or all of the features described herein.

In addition, the information of storage system 450 may store information about the status and characteristics of each vehicle of the fleet, as discussed above, as well as the map information discussed above. As the vehicles of the fleet drive around, they may constantly and/or periodically broadcast to the one or more of the server computing devices 410 of the fleet management system their status. This may include, for example, whether the vehicle is currently on a trip (e.g. is transporting passengers and/or cargo), a current destination of the vehicle and/or one or more additional future destinations for the vehicle (as discussed further below), whether the vehicle has any maintenance needs, etc. As an example, maintenance needs may include whether the vehicle needs cooling or shade, refueling or charging, cleaning, periodic inspection (after so many hours, trips, or miles in service), re-calibration of sensors (to address faults or periodic maintenance), or other maintenance. The one or more server computing devices 410 may store his information in storage system 450.

The storage system 450 may also store information about requests for customer service. This information may include, for instance, a type of the request, how the request was originated, a vehicle of the fleet associated with the request, when the request was generated (a timestamp), an associated priority level, whether the request is assigned to a queue (and if so, which if there is more than one queue), whether the request is completed, etc. In addition, the storage system 450 may also be used to store the aforementioned queues and/or the information about the queues as discussed further below.

The storage system 450 may also store information about customer service representatives, such as user 442. This may include information for each customer service representative, such as the number of requests serviced, passenger (or users) of the server which the customer service representative has communicated with previously, as well as characteristics of that customer service representative, such as level of experience, ranking or ratings, skill set, certification, language spoken, or other such characteristics.

In order to provide transportation services to users, the information of storage system 450 may include user account information such as credentials (e.g., identifiers such as a username and password as in the case of a traditional single-factor authentication as well as other types of credentials typically used in multi-factor authentications such as random identifiers, biometrics, etc.) that can be used to identify a user to the fleet management system. The user account information may also include personal information such as the user's name, contact information, identifying information of the user's client computing device (or devices if multiple devices are used with the same user account), one or more unique signals for the user, whether the user has chosen to opt for one or more different pre-determined levels of service or otherwise has a need for accessibility services, as well as other user preference or settings data.

As with memory 130, storage system 450 can be of any type of computer storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4 and/or may be directly connected to or incorporated into any of the computing devices 110, 410, 420, 430, 440, etc.

### Example Methods

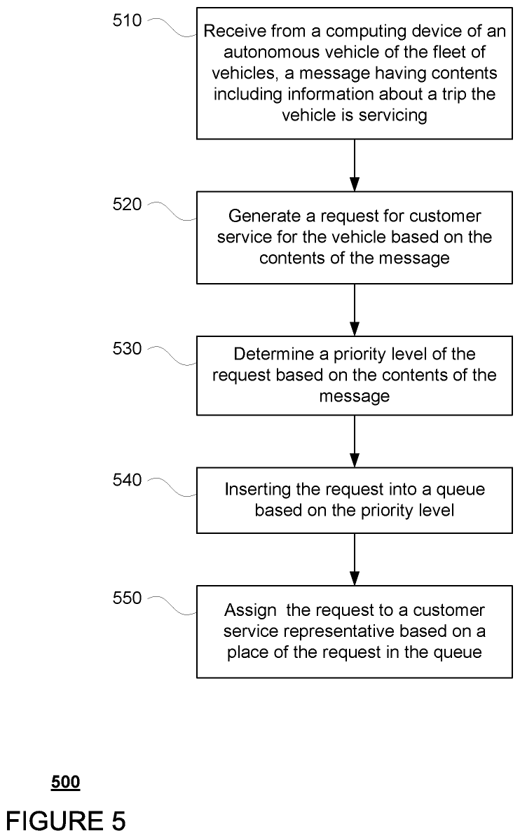

In addition to the operations described above and illustrated in the figures, various operations will now be described. It should be understood that the following operations do not have to be performed in the precise order described below. Rather, various steps can be handled in a different order or simultaneously, and steps may also be added or omitted. For instance, FIG. 5 is an example flow diagram 500 that may be performed by one or more processors such as one or more processors of the server computing devices 410 in order to assign requests for customer service or customer service requests for a fleet of autonomous vehicles providing trip services, such as vehicles 100, 100A, and 100B.

One or more of the server computing devices 410 of the fleet management system may automatically generate requests for customer service based on various input. As shown in block 510 of FIG. 5, a message having contents including information about a trip the vehicle is servicing (or currently servicing) is received from a computing device of an autonomous vehicle of the fleet of vehicles. Such messages may include some or all current state information for the vehicle that generated the request. For instance, in some examples, state messages may be self-consistent and generated based on rules about packaging the messages from various systems of the vehicles, such as the deceleration system 160, acceleration system 162, steering system 164, signaling system 166, navigation system 168, positioning system 170, perception system 172, power system 174, etc. As an example, the messages may include vehicle telemetry such as pose (location and orientation), lane information (i.e. in what lane the vehicle is currently traveling), as well as other information, such as whether the vehicle is currently providing transportation services, experiencing any errors or problems, etc. In this regard, the state message may include information about a trip that the vehicle is currently servicing. The messages may also include other types of information from various internal sensing systems such as various types of camera images of the interior and exterior of the vehicle, and input from drivers or passengers via the UI systems in the vehicle. Each vehicle may periodically generate and send a state message. For example, the computing devices 110 may periodically generate a state message and broadcast that message over network 460 and/or send the message to one or more of the server computing devices 410. In addition or alternatively, rather than a single periodic state message, various systems of the vehicle may communicate directly with the one or more computing devices 410 of the fleet management system via network 460.

The one or more server computing devices may then determine whether a request for customer service should be generated and if so, generate a request based on the content of the message as shown in block 520 of FIG. 5. Each request may include information such as a request identifier, a timestamp, a type of the request or other indication of why the request was generated, any requirements of the request, a vehicle identifier for the vehicle for which the request was generated, and other details and information.

The requests may be generated, for instance, based on a set of heuristics. For instance, if a state message indicates that a vehicle has been in a collision, the one or more computing devices 410 of the fleet management system may automatically generate a request. As another instance, if a trip (i.e. a trip to transport passengers and/or cargo) has just ended, the one or more computing devices 410 may automatically generate a request so that a customer service representative can check the interior status (e.g. is it clean or dirty) of the vehicle before assigning the vehicle to a new trip. As another instance, if a state message indicates that the vehicle has not moved for some period of time or is otherwise stuck, the one or more of the server computing devices 410 of the fleet management system may automatically generate a request. Other examples for generating requests may be based on seat belt checking, pre-ride and post ride checks (for cleanliness or lost articles), display screen issues, fuel door being open, passenger taking a long time to get out of the vehicle, the frunk or trunk are open, error messages for the vehicle (such as low tire pressure, low fuel, problems with a display screen or sensor of the vehicle, such as an internal camera, etc.), a request to pull the vehicle over made by a passenger within the vehicle (for instance, using a button of the vehicle and/or the passenger's client computing device), etc.

As another example, one or more server computing devices 410 may automatically generate a request based on a lack of a status message from a vehicle. For instance, if a vehicle goes too long without reporting its status, for instance longer than a predetermined period, such as 1 minute or more or less, this may be an indication of a problem at the vehicle. As such, the one or more of the server computing devices 410 of the fleet management system may automatically generate a request.

Requests may also be generated based on specific requests made by a passenger or another type of non-customer service representative. For example, a passenger may use some user input, such as a physical or virtual (on a touch screen) “call button” within the vehicle and/or on the passenger's client computing device to indicate that the passenger wants to reach a customer service representative. This may cause the vehicle to send this information to one or more of the server computing devices 410, for instance via the state message or another type of message. In addition or alternatively, if the passenger uses his or her client computing device to indicate that the passenger wants to reach a customer service representative, the passenger's client computing device may send this information to one or more of the server computing devices 410. As another example, a request may also be made if the one or more of the server computing devices 410 of the fleet management system detects unexpected input (i.e., button press, windows/door opening) while no passenger is expected in the car (i.e., car is in between trips). As a further example, a dispatcher or other human agent who may be monitoring a vehicle remotely, for instance via a computing device such as computing device 440, and notices an actual or potential issue with a vehicle may send information identifying the problem to the one or more of the server computing devices 410 of the fleet management system. Once the information is received, the one or more of the server computing devices 410 of the fleet management system may automatically generate a request.

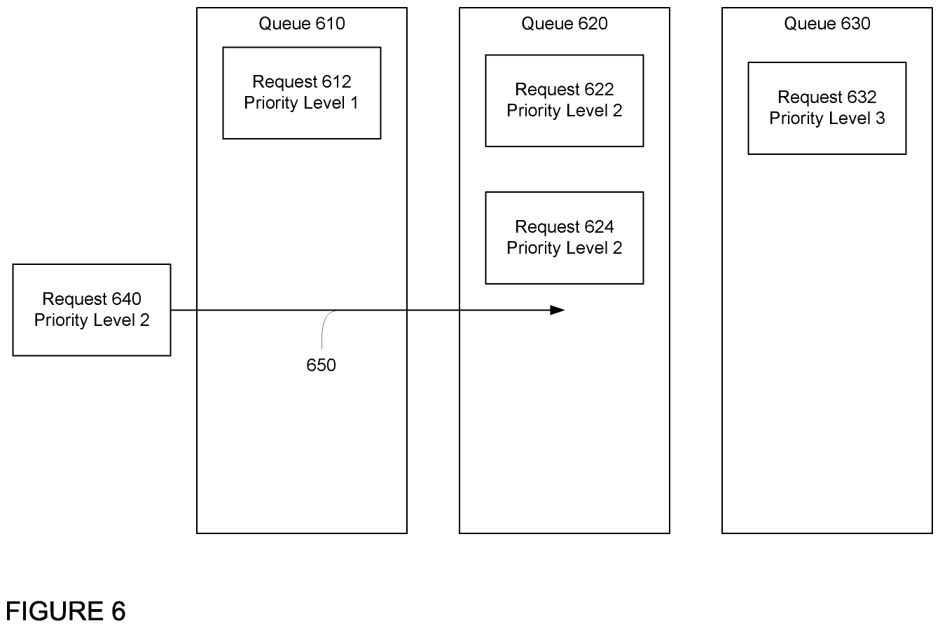

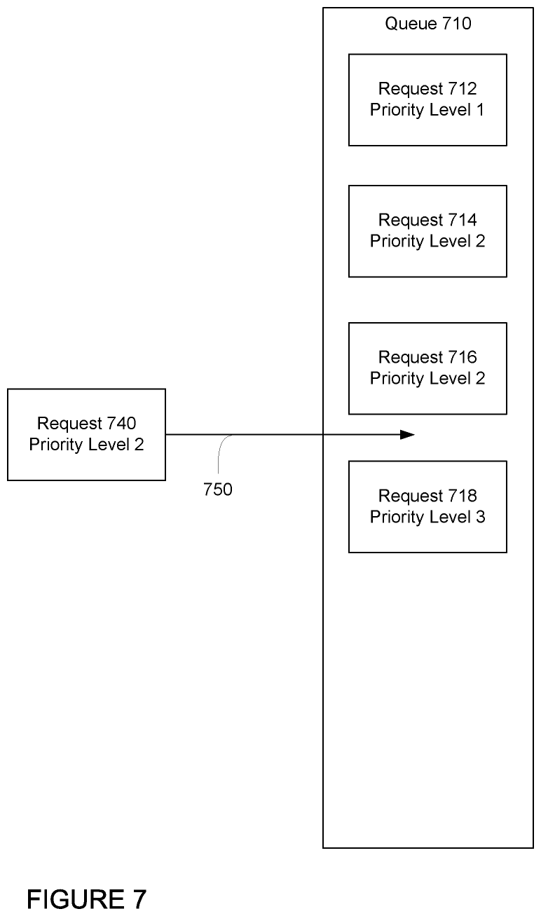

As shown in block 530, a priority of the request is determined based on the contents of the message. For instance, once a request is generated, it may be assigned a priority by one or more of the server computing devices 410 based on the reason or context for the request being generated. These priority assignments may also be made based on heuristics. For instance, the more related or relevant the context of the request is to safety the higher the priority. Similarly, if the vehicle is occupied, the same type of request may be associated with a higher priority level than if the vehicle is unoccupied. As an example, in a scale where higher priority levels represent higher priorities (such as in the examples of FIGS. 6 and 7), requests generated based on collisions may always be assigned a highest priority level. Requests generated based on a post-ride cleanliness check may be assigned a lower priority level. At the same time, requests generated based on user input may be assigned a priority level somewhere in between and requests generated based on a passenger opening a door of a vehicle while the vehicle is moving or a safety check for a minor or an infirm passenger may be assigned a priority level less than the user input example, but greater than the cleanliness example. Of course, in some instances, requests generated based on a passenger opening a door while a vehicle is moving or safety checks for a minor or infirm passenger may be a higher level, or close to highest level.

Moreover, similar types of requests may still be assigned different priority levels based on additional context and information. For example, checks on passengers may be more frequent for minors or infirm people than for adults traveling at night. As another example, a request for a cleanliness check may be assigned a higher priority for a trip where the passenger or cargo is known to leave the vehicle dirty (e.g., based on a history of cleanliness checks associated with the passenger, or the cargo is of a type that sheds or leaves dirt or other remnants that require clean-up), or where the pick-up location indicates a likelihood of requiring clean-up (e.g., weather and/or type of location indicates passengers will track in dirt, mud, leaves, bugs, pollen, chemicals, dirty cargo). Similarly, a request for a cleanliness check may be assigned a lower priority level where the passenger, cargo, or location, is known to leave the vehicle clean. As another example, requests based on user input may be prioritized over other types of requests based on whether a passenger has chosen to opt for one or more different pre-determined levels of service or otherwise has a need for accessibility services. For instance, passengers may opt for a higher level of service which may correspond to a higher priority level with regard to requests for customer service.

As shown in block 540, the request is inserted, or placed, into a queue by one or more of the server computing devices 410 based on the determined priority level for the request. In one instance, there may be a plurality of different queues, each with a different priority level associated with it. Here, a request may be inserted or placed at the end of a que associated with the same priority level as assigned to the request. FIG. 6 is a visual representation of assigning a request to one of a plurality of queues. In this example, there are three priority levels: priority level 1, 2, 3. In an example, priority level 1 may be a highest priority level, and priority level 3 may be a lowest priority level. Priority level 2 may be a level between priority levels 1 and 3. As such, there are three queues: queues 610, 620, 630. Queue 610 is associated with priority level 1 and includes request 610. Queue 620 is associated with priority level 2, and includes requests 622, 624. Queue 630 is associated with priority level 3 and includes request 632. Each request in each queue is therefore associated with a determined priority level corresponding to that of the queue as well as a timestamp, any requirements of the request, a vehicle identifier (vehicle ID), and other details. Requests may be assigned to a queue in the order they are generated such that older requests are placed towards the top of the queue. In this regard, request 622 may have an older timestamp than request 624. As shown, a new request 640, associated with a determined priority level of 2, is received and may be assigned to the bottom of queue 620 as indicated by arrow 650.

In some instances, queues 610, 620, 630 may represent different types of priorities or categories of customer service requests, for example associated with different types of customer service requests or different capabilities of customer service representatives, rather than different priority levels. For example, queue 610 may be for customer service requests associated with vehicle failures, queue 620 may be for customer service requests associated with collisions, queue 630 may be for customer service requests associated with post-load checks (i.e., issues arising after drop off of passenger or cargo), and additional queues (not shown) may exist for other categories of customer service requests or types of requests requiring specific customer service skills (e.g., speaks a certain language, has a certain certification, escalation to a certain level, etc.).

As another instance, there may be a single queue. Rather than inserting the request at the end of the queue, the request may be inserted in the queue at a location that is no higher than any other request with the same determined priority level. FIG. 7 is a visual representation of assigning a request to a single queue based on a determined priority level for the request. In this example, there are three priority levels: priority level 1, 2, 3. In this example, priority level 1 may be a highest priority level, and priority level 3 may be a lowest priority level. Priority level 2 may be a level between priority levels 1 and 3. In this example, there is a single queue: queues 710. Queue 710 includes requests 712, 714, 716 and 718 arranged by both priority level as well as timestamp. In this regard, request 622 may have an older timestamp than request 624. Each request is also associated with a determined priority level corresponding to that of the queue as well as a timestamp, any requirements of the request, a vehicle identifier (vehicle ID), and other details. As shown, a new request 740, associated with a determined priority level of 2, is received and may be assigned to the queue between request 716 and request 718. In other words, request 740 is inserted above any requests associated with a determined priority level lower than priority level 2, below any requests with the same priority level (i.e. priority level 2) having an earlier timestamp than request 740, and also below any requests with a higher priority level than priority level 2.

As shown in block 550, the request may be assigned to a customer service representative based on a place of the request in the queue, for instance, relative to other requests in the queue. The request may also be assigned based on the availability of the customer service representative (i.e. whether the customer service representative is already addressing another request for customer service). For instance, wherein there are multiple queues, the request with the oldest or earliest timestamp, and if there are multiple queues, in the highest priority queue with at least one unassigned request may be the next assigned request. In some instance, the assignments may be based on whether a customer service representative meets any requirements of the request. For example, a request related to a collision or a vehicle being stuck on a highway may require that the customer service representative have a particular level of experience, ranking or ratings, skill set, certification, or other such characteristic. As another example, a request from a Spanish speaking passenger may require a customer service representative who is fluent in Spanish. Accordingly, the one or more of the server computing devices 410 of the fleet management system may track the availability of each customer service representative as well as his or her characteristics as discussed above with regard to storage system 450. In this regard, requests are only assigned to customer service representatives equipped to handle those requests. In some instances, the fleet management system may also track which customer service representatives were assigned to requests for which vehicles and/or passengers such that if available, the same customer service representative may be assigned to the same vehicle and/or passengers.

Once the request is assigned to a customer service representative, one or more of the server computing devices 410 may also record that the customer service representative has been assigned to a particular request. In some instance, the request may remain in its assigned queue, but may be flagged as assigned or otherwise such that it is ignored when the one or more of the server computing devices 410 of the fleet management system is ready to assign a new task.

The one or more of the server computing devices 410 of the fleet management system may also facilitate a connection between the assigned customer service representative and the vehicle. For instance, one or more of the server computing devices 410 may initiate a voice over IP (VOIP) call between a computing device of the assigned customer service representative and the vehicle. In some instances, the one or more of the server computing devices 410 of the fleet management system may also or alternatively initiate a VOIP or telephone call with the passenger's client computing device (e.g. mobile phone. This may be especially useful if there is a problem with the network connection or particular systems of the vehicle.

The customer service representative may access information about the vehicle from the storage system 450. This may include any additional unassigned requests for that vehicle. In that regard, the customer service representative may also be able to view any lower priority requests, which have not yet been assigned to a customer service representative, as well. For instance, if a first request is initiated by a vehicle's computing devices because the vehicle has become stuck and a second request is initiated by a passenger using a “pull over” button or option, each of the first and second requests may be entered into the one or more queues independent of one another and according to their respective priority levels. Once one of the first or second requests is assigned to a customer service representative, when that customer service representative accesses information about the vehicle, he or she may not only see the assigned task, but also the unassigned task. In this regard, the customer service representative is able to review and respond to both the first request and the second requests. This allows the requests for a given vehicle to be entered into the queue separately but addressed at the same time according to the request with the higher priority level without requiring the one or more of the server computing devices 410 of the fleet management system to actually assign both tasks to the same customer service representative.

The customer service representative may respond to a request, for instance, by communicating with any passengers in the vehicle. In some instances, the customer service representative may send another vehicle to retrieve the passenger. In addition or in other cases where there is no passenger, the customer service representative may take the vehicle out of service, such as if there is a very dirty interior or broken item in the vehicle. Of course, this may be based on current demand for vehicles. For example, if demand for vehicles is currently high, a customer service representative might choose to keep a dirty car in service for longer than if there were low demand. A customer service representative may also send instructions via his or her client computing device or cause one or more of the server computing devices 410 to send instructions to the vehicle to pull over or change its route, but not necessarily control the actual movements of the vehicle.

Once a customer service representative has addressed the reason for the request and/or communicated with any passengers of the vehicle, the customer service representative may designate the request as completed, closed, etc. In response, one or more of the server computing devices 410 may remove the request from its queue. Alternatively, rather than flagging the request as assigned, the request may be removed from the queue, but the status of the request tracked to ensure that it is designated as completed within some period of time.

In some instances, where there is a high priority level request in a queue to be assigned, but no customer service representatives to which to assign the request, the one or more of the server computing devices 410 of the fleet management system may change its queueing behavior. For instance, the server computing devices 410 may stop assigning requests with lower priority levels to a queue when very high priority requests are unassigned. For example, returning to an example of three priority levels (as in the examples of FIGS. 6 and 7) if there is a collision which may have a priority level of 1, the server computing devices, may stop assigning tasks with a priority level of 3, such as those related to seat belt checking, pre-ride and post ride checks, display screen issues, fuel door being open, passenger taking a long time to get out of the vehicle, if the frunk or trunk are open, etc.

The one or more of the server computing devices 410 of the fleet management system may also make changes to the queue or queues based on a load-level of the customer support representatives. For instance, if the total number of requests is high relative to a number of customer support representatives answering requests, the load-level for the customer service representatives may be high. In such cases, some requests with lower priority levels may be dropped from the queue or queues. For example, returning to an example of three priority levels (as in the examples of FIGS. 6 and 7) if there are 10 available customer service representatives currently taking requests and 30 requests to assigned, one or more server computing devices 410, may remove requests with a priority level of 3 from a queue.

In some instances, there may also be different queues for different types of requests for customer service. For instance, there may be independent queues for typical passengers and for test drivers who are “passengers” in vehicles during testing. The requests in these queues may be assigned to customer service representatives with specialized skills, for instance technical knowledge of the vehicle and its self-driving systems. In this regard, these customer service representatives may be able to troubleshoot issues with the vehicle and/or connect the test drivers with the appropriate support system or support personnelle. These customer service representatives may be the same or different from those discussed above who communicate with typical passengers.

As noted above, because the requests are generated by the fleet management system and not necessarily the vehicles themselves, this may prevent vehicles from calling customer service too often and for unnecessary reasons thereby dynamically managing (e.g., reducing, limiting, reassigning) the load on the customer service representatives. In addition, by using priority level, the fleet management system is able to prioritize the most important (i.e. highest priority level) requests and also to moderate the load on any given customer service representative.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of assigning customer service requests for a fleet of autonomous vehicles providing trip services, the method comprising:
receiving, by one or more server computing devices, from a computing device of an autonomous vehicle of the fleet of vehicles, a message having contents including information about a trip the vehicle is servicing;
generating, by the one or more server computing devices, a request for customer service for the vehicle based on the contents of the message;
determining, by the one or more server computing devices, a priority level of the request based on the contents of the message;
inserting, by the one or more server computing devices, the request into a queue based on the priority level; and
assigning, by the one or more server computing devices, the request to a customer service representative based on a place of the request in the queue.

2. The method of claim 1, wherein generating the request is further based on a set of heuristics including whether a trip has been completed.

3. The method of claim 1, wherein generating the request is further based on a set of heuristics including whether a trip has ended.

4. The method of claim 1, wherein generating the request is further based on a set of heuristics including whether the vehicle appears to be stuck.

5. The method of claim 1, wherein generating the request is further based on a lack of messages from the vehicle for a predetermined period of time after the messages is received.

6. The method of claim 1, wherein determining the priority level is further based on past history of a passenger of the vehicle.

7. The method of claim 1, wherein the message includes an indication that a passenger of the vehicle is requesting customer service, and wherein determining the priority level is further based on the indication.

8. The method of claim 7, wherein determining the priority level is further based on a pre-determined level of service for the passenger.

9. The method of claim 1, wherein the message is a status message identifying a current status of the vehicle, and wherein determining the priority level is further based on the current status of the vehicle.

10. The method of claim 1, wherein determining the priority level is further based on a set of heuristics including whether the vehicle is occupied.

11. The method of claim 1, wherein determining the priority level is further based on a set of heuristics including whether the request is related to safety of a passenger.

12. The method of claim 1, wherein determining the priority level is further based on a set of heuristics including whether the request is related to safety of the vehicle.

13. The method of claim 1, wherein inserting the request into the queue includes selecting the queue from a plurality of queues each having a different associated priority level.

14. The method of claim 13, wherein selecting the queue includes identifying one of the plurality of queues having a determined priority level corresponding to the priority level.

15. The method of claim 14, wherein assigning the request is based on whether any other queues having a higher priority level than the priority level are empty.

16. The method of claim 1, wherein inserting the request includes inserting the request in the queue at a place that is no higher than any other request in the queue with a same priority level as the priority level.

17. The method of claim 1, wherein assigning the request is further based on a characteristic of the customer service representative and a type of the request.

18. The method of claim 17, further comprising, tracking a status of the customer service representative and updating the status once the request is assigned to the customer service representative.

19. The method of claim 1, further comprising:
receiving an indication that the customer service representative has closed the request; and
removing the request form the queue based on the indication.

20. The method of claim 19, wherein the indication further indicates that the customer service representative has closed a second request for customer service for the vehicle, wherein the second request was not assigned to the customer service representative, and the method further comprises removing the second request form the queue based on the indication.
